(19) United States
(12) Patent Application Publication
(10) Pub. No.: US 2017/0303725 A1
(43) Pub. Date: Oct. 26, 2017

(54) APPARATUS, SYSTEM AND RELATED METHOD FOR INFUSION OF MATERIAL IN A LIQUID

(71) Applicant: Joseph Morris Buchbinder, New York, NY (US)

(72) Inventor: Joseph Morris Buchbinder, New York, NY (US)

(21) Appl. No.: 15/389,014

(22) Filed: Dec. 22, 2016

Related U.S. Application Data
(60) Provisional application No. 62/325,692, filed on Apr. 21, 2016.
(60) Provisional application No. 62/362,558, filed on Jul. 14, 2016.
(60) Provisional application No. 62/423,911, filed on Nov. 18, 2016.

(51) Int. Cl. A47J 31/00; A47J 31/44

(52) U.S. Cl. CPC A47J 31/005; A47J 31/4407

(57) ABSTRACT

The present invention discloses embodiments of an apparatus, systems and related methods for producing infusions. Embodiments of the present invention disclose a cup having a container of infusion material, such as tea, where the user may affect the mechanical structures of the cup to interact with the container of infusion material in such a way as to selectively bring the liquid into contact with the infusion material in order to produce the desired infusion. The present invention also includes a new method of creating an infusion utilizing the disclosed apparatus. The result of the invention also provides enhancements over the prior art, such that the infusion material may be used to multiple times in order to produce multiple infusion servings before disposing of the spent material.

### CROSS-REFERENCE TO RELATED APPLICATIONS

This U.S. Non-Provisional Patent Application claims the benefit of U.S. Provisional Patent Application No. 62/325,692, filed on Apr. 21, 2016, now pending, U.S. Provisional Patent Application No. 62/362,558, filed on Jul. 14, 2016, now pending, and U.S. Provisional Patent Application No. 62/423,911, filed on Nov. 18, 2016, now pending, and all are incorporated by reference as if fully set forth here.

### STATEMENT REGARDING FEDERALLY SPONSORED RESEARCH OR DEVELOPMENT

None.

### FIELD OF THE INVENTION

This invention relates generally to the field of apparatus for preparation of infusion mixtures and, more specifically, to apparatus, systems and related methods for infusion of material in a liquid such as, but not limited to, the infusion of tea leaves in hot water.

### BACKGROUND

It is known in the art to steep some quantity of dry material in a liquid in order to extract components from the dry material to be infused into the liquid. One such example is the steeping of dried tea leaves in hot water in order to extract the flavor and nutrients of the dried leaves into the water.

Typically, the dry component is contained in some sort of a water-permeable container, such as a mesh bag, and submerged into the hot or boiling water. After a predetermined period of time, the dry components are removed from the water, the desired amount of infusion having taken place. Over the centuries, this process has been accomplished manually. In many cultures, this infusion process, especially with teas, is ceremonial in nature.

The present, always on-the-go, culture embraced by many around the world leaves little time or patience for the proper infusion of tea, or other materials. While drinking tea has risen in popularity due to its health benefits, many forego the beverage in favor of the quicker, and more readily available, disposable cup of coffee.

The problem here is that tea drinkers want to be able to control the amount of time that the tea is in contact with the water in order to achieve the perfect strength and flavor. Even with disposable cups and tea bags, the problem of what to do with the wet tea bag when you extract it is a concern. Many types of leaves are also capable of creating multiple cups of tea, but what does a user do with the tea bag in between steeping?

Many attempts have been made in the art in order to create an apparatus for infusing tea, or other dry substances, into a liquid. Some merely create a separate compartment for holding the tea bag, but this fall short because of the problem of what to do with the wet bag once used up. Other attempts, create cages or other permeable mechanisms for holding the infusion material, but these fall short because they are not disposable.

It would, therefore, be desirable to have an apparatus, system and related method for infusing a liquid with a substance, where the user can control the amount of time that the liquid is in contact with the infusion material. It would be further desirable for the apparatus and infusion material to be self-contained and disposable.

While certain aspects of conventional technologies and methods in the relevant art have been discussed to facilitate disclosure of the invention, Applicant in no way disclaims these technical aspects or methods, and it is contemplated that the claimed invention may encompass one or more of the conventional technical aspects or methods discussed herein.

In this specification, where a document, act, or item of knowledge is referred to or discussed, this reference or discussion is not an admission that the document, act, or item of knowledge or any combination thereof was, at the priority date, publicly available, known to the public, part of common general knowledge, or otherwise constitutes prior art under the applicable statutory provisions; or is known to be relevant to an attempt to solve any problem with which this specification is concerned.

### SUMMARY

In this specification and in the appended claims and drawings, words and phrases have the meanings commonly attributed to them in the relevant art except as otherwise specified herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

For clarity and compactness of disclosure, the embodiments disclosed and discussed herein are described in the context of infusing, or steeping, dried tea leaves in hot or boiling water. It should be clear to a person having ordinary skill in the art, that the apparatus, system and method disclosed herein may be applied in embodiments to other materials and infusions such as, but not limited to, coffee, soup, and other food-stuffs, as well as, pharmaceuticals, nutraceuticals, and related medicinal applications.

In view of the foregoing, an embodiment of the invention is directed toward a self-contained cup with integral infuser that provides the user with control over the duration of time that the infusion material is in contact with the surrounding liquid. Embodiments of the invention are easier, cleaner, and safer to use when compared to other solutions in the art. Furthermore, embodiments of the present invention are capable of being manufactured completely out of disposable and recycled/recyclable materials.

Embodiments of the invention contemplate an apparatus for infusing material into a surrounding liquid, the apparatus comprising: a vessel, having a vessel body defining a vessel interior and a vessel exterior, the vessel interior configured to contain a liquid, and the vessel body configured to be locally deformable, variable between a deformed state and an undeformed state; and a container, having a container body defining a container interior and a container exterior, the container interior configured to contain an infusion material, and the container body configured with a one or more perforation integral to the container body passing from the container exterior to the container interior, where said container is operatively communicative with said vessel interior such that when said vessel body is in said undeformed state the one or more perforation is in contact with said vessel body, and when said vessel body is in said deformed state the one or more perforation is separated from said vessel body and thereby exposed to said vessel interior.

While some variations of infusers exist in the art, the present invention provides superior quality and control, due to inventive construction, by providing, in embodiments, a paper cup or a flexible wall cup, an upper sleeve, a lower sleeve, and a container, with some embodiments incorporating additional, different, or fewer parts. The container houses a variety of styles and types of tea, coffee, or other infusing materials and is located inside the cup, preferably attached to the side wall or bottom of the teacup. The tea container can be filled by the user or pre-filled by the manufacturer. In embodiments, a sleeve will push, rotate or otherwise affect the internal tea container to allow the contents of the container to be exposed to the surrounding water, thereby causing a steeping or infusing action. The sleeve may be located on the side wall or under the cup. The user can also halt the flow of water to the container's contents and stop the steeping action. Embodiments of the present invention also include a new system and related method of infusing tea, or other substances, utilizing the described apparatus.

The resulting apparatus, and related system and method, allows the user to selectively control when the tea or other infusing product is interacting and mixing with the surrounding liquid. The user can safely and easily control the strength of the tea or other infusing substance. Embodiments of the present invention provide a convenient way to consume tea on-the-go without the need for tea bags.

Since the tea remains within the cup and receives controlled exposure to the liquid placed in the cup, the product encourages reuse of the same infusing material (multiple steeps). This also avoids the mess typically associated with removing and throwing away tea bags or tea infusers. Additionally, embodiments provide an easy sifting mechanism without the need to place your hand near the water.

In the case of embodiments incorporating a lid, the infusing product can be steeped without removing the lid as is required in many other attempted solutions found in the art. Furthermore, the infusing substance can be mixed evenly without using a separate stirrer.

Other advantages of the present invention over the current state of the art are that the invention provides enjoyable functionality, as well as, reduced shelf space at home, work and at retail stores, as the apparatus can be stacked for easier storage. Furthermore, the inventive infusion mechanism can use higher quality, loose-leaf tea.

Embodiments of the invention may further be insulated to protect the user from inadvertently contacting hot portions of the cup.

### BRIEF DESCRIPTION OF THE DRAWINGS

These and other features, aspects, and advantages of the present invention will become better understood with regard to the following description, appended claims, and accompanying drawings where:

FIG. 1—is a perspective view of the apparatus according to an embodiment of the invention.

FIG. 2—is an exploded perspective view of the apparatus shown in FIG. 1 according to an embodiment of the invention.

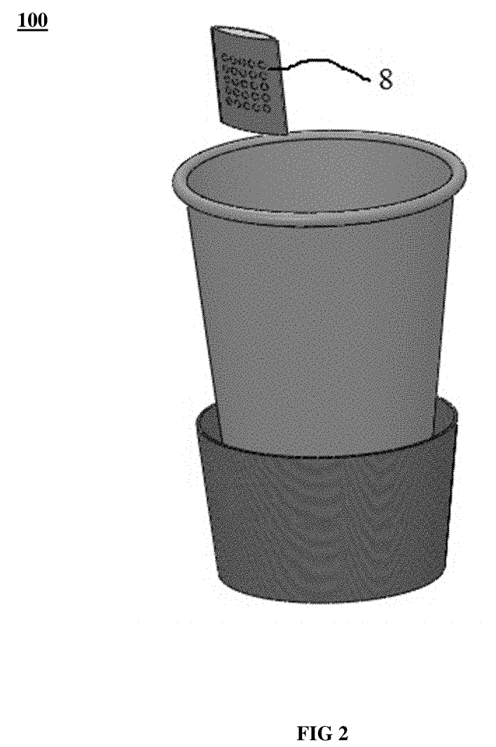

FIG. 3—is the container from the apparatus shown in FIG. 1 according to an embodiment of the invention.

FIG. 4—is a perspective view of the sleeve from the apparatus shown in FIG. 1 according to an embodiment of the invention.

FIG. 5—is a perspective view of an alternative sleeve from the apparatus shown FIG. 1 according to an embodiment of the invention.

FIG. 6—is a bottom view of the sleeve from FIG. 5 according to an embodiment of the invention.

FIG. 7—is a perspective view of an alternative sleeve from the apparatus shown in FIG. 1 according to an embodiment of the invention.

FIG. 8—is a top view of the sleeve in FIG. 7 according to an embodiment of the invention.

FIG. 9—is a top view of a sleeve, tea container and cup according to an embodiment of the invention.

FIG. 10—is a perspective view of the tea container from the apparatus shown FIG. 9 according to an embodiment of the invention.

FIG. 11—is a perspective view of the sleeve from the apparatus shown in FIG. 9 according to an embodiment of the invention.

FIG. 12—is a perspective view of an embodiment of the apparatus showing a sleeve, tea container, and cup according to an embodiment of the invention.

FIG. 13—is a perspective view of the apparatus shown in FIG. 12 with an overlaid sealing paper according to an embodiment of the invention.

FIG. 14—is a top view of the apparatus shown FIG. 13 according to an embodiment of the invention.

FIG. 15—is perspective view of an embodiment of an apparatus showing a sleeve, tea container, and cup according to an embodiment of the invention.

FIG. 16—is a perspective view of the tea container from the apparatus shown in FIG. 15 according to an embodiment of the invention.

FIG. 17—is a perspective view of another tea container according to an embodiment of the invention.

FIG. 18—is a front view of an apparatus showing a cup with an upper and lower sleeve according to an embodiment of the invention.

FIG. 19—is a side view of the apparatus shown in FIG. 18 according to an embodiment of the invention.

FIG. 20—is a side view of the apparatus shown in FIG. 18 with a different sleeve holder according to an embodiment of the invention.

FIG. 21—is a top view of an apparatus according to an embodiment of the invention.

FIG. 22—is a perspective view of an isolated container according to an embodiment of the invention.

FIG. 23—is a side view of the apparatus shown in FIG. 21 with the cup shown in wireframe and the container in the closed position according to an embodiment of the invention.

FIG. 24—is a side view of the apparatus shown in FIG. 21 with the cup shown in wireframe and the container in the open position according to an embodiment of the invention.

FIG. 25—is a perspective view of a container attached to an attaching member according to an embodiment of the invention.

FIG. 26—is a top view of an apparatus with the container in the open position according to an embodiment of the invention.

FIG. 27—is a perspective, section view of an apparatus with the container in the open position according to an embodiment of the invention.

FIG. 28—is a perspective, section view of an apparatus with the container in the closed position according to an embodiment of the invention.

FIG. 29—is a perspective, wireframe view of the container shown FIG. 25.

FIG. 30—is an exploded view of an apparatus according to an embodiment of the invention.

FIG. 31—is a top view of the apparatus shown in FIG. 30 according to an embodiment of the invention.

FIG. 32—is a bottom view of the container from the apparatus shown in FIG. 30 according to an embodiment of the invention.

FIG. 33—is a perspective view of the container from the apparatus shown in FIG. 30 according to an embodiment of the invention.

FIG. 34—is a perspective view of the support bracket from the apparatus shown in FIG. 30 according to an embodiment of the invention.

FIG. 35—is a perspective view of the lower ring from the apparatus shown in FIG. 30 according to an embodiment of the invention.

FIG. 36—is a perspective view of the piston from the apparatus shown in FIG. 30 according to an embodiment of the invention.

FIG. 37—is a bottom perspective view of the piston from the apparatus shown in FIG. 30 according to an embodiment of the invention.

FIG. 38—is a front view of the apparatus only showing the lower ring and cup from the apparatus shown in FIG. 30 according to an embodiment of the invention.

### DESCRIPTION

In the Summary above, in the Description and appended Claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components.

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm.

In this specification and in the appended claims and drawings, “tea”, including grammatical equivalents, singular and plural, is to be understood as a composition of matter that is to be infused into a surrounding liquid. References throughout this disclosure to “tea” is meant to include all types of tea leaves including whole leaf teas. The use of the term “tea” throughout this specification may also include any other matter capable of being infused in a surrounding liquid such as, but not limited to, coffee, dehydrated soup or broth, or pharmaceuticals, nutraceuticals, and related medicinal compositions of matter.

In this specification and in the appended claims and drawings, “teacup”, “cup”, and other such terms, including grammatical equivalents, singular and plural, are to be understood as a vessel for holding and/or drinking a liquid regardless of shape or material of construction.

The terms “adapted” and “configured” are used interchangeably herein to state that a system or apparatus and machine can perform a certain function and is recited herein to provide guidance to those skilled in the art as to the scope of the claim.

Any element in a claim that does not explicitly state “means for” performing a specified function, or “step for” performing a specific function, is not to be interpreted as a “means” or “step” clause as specified in 35 U.S.C. §112, ¶6. In particular, the use of “step of” in the claims herein is not intended to invoke the provisions of 35 U.S.C. §112, ¶6.

While the specification will conclude with claims defining the features of embodiments of the invention that are regarded as novel, it is believed that the invention will be better understood from a consideration of the following description in conjunction with the figures, in which like reference numerals are carried forward.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein. Specifically, component names, types, and values, as depicted in the exemplary schematic diagrams, are not intended to limit the scope of the present invention and are presented only as possible embodiments.

For purposes of clarity and simplicity of disclosure, but not of limitation, we describe the various embodiments of the invention in the environmental context of user steeping tea in water for on-the-go consumption.

It will be readily understood by those having skill in the art that an apparatus, system and related method for infusion of dry material into a liquid, such as the one disclosed herein, may also be utilized in other environments or applications where it is desirable to provide a user with an infused liquid.

The various embodiments disclosed and described in this specification, as well as in the appended claims and drawings, are drawn to an apparatus comprising a container and a vessel, such as a cup.

The container is configured such that the interior cavity of the container may be loaded with a desired material. This material may be, by way of example and not limitation, tea leaves, coffee, protein powder, spices, energy powder, dried fruit, or medications. The material, once placed in the container, is sealed off from the environment outside of the container except via a selected area on the container which is configured with one or more perforations. Through these perforations, and only through the perforations, may the contents of the container come into contact with the surrounding environment.

The vessel, such as a cup, is selected to be suitable for the intended use or purpose. For example, if the purpose is to have a disposable cup for drinking tea, then an 8 or 16 ounce disposable paper cup may be selected.

The container is combined with the vessel, the combination configured so that the perforations of the container are sealed off from the interior of the vessel until such time as a user selectively interacts with the vessel, a portion of the vessel, or a component communicative with the vessel, and via said interaction causes the perforations of the container to be exposed to the surrounding environment.

To illustrate, embodiments of the invention may include a container, as described herein, filled with tea leaves, and a disposable paper cup capable of receiving hot water. The container is attached to the interior of the paper cup so that, in its normal state, the perforations of the container are pressed, or basically sealed, against the paper cup's side wall. The user may then fill the paper cup with hot water. Since the container is pressed against the paper cup's side wall, the water does not pass through the perforations to mingle with the tea held within. Next, the user would, for example in this embodiment, locally deform the paper cup's sidewall, causing the perforations of the container to momentarily separate from the sidewall, thereby allowing the hot water to co-mingle with the tea leaves. When the desired infusion strength is reached, the user would release the deformation, thereby bringing the paper cup back to its normal state and sealing the container perforations back against the paper cup's sidewall. The user may also desire to repeatedly deform the cup in order to achieve a “sifting” motion of the hot water flowing back and forth through the container perforations.

By using embodiments of the apparatus disclosed herein, a user may achieve more than one cup of infused liquid, such as with whole leaf tea, simply by refilling the cup with more hot water and repeating the infusion process.

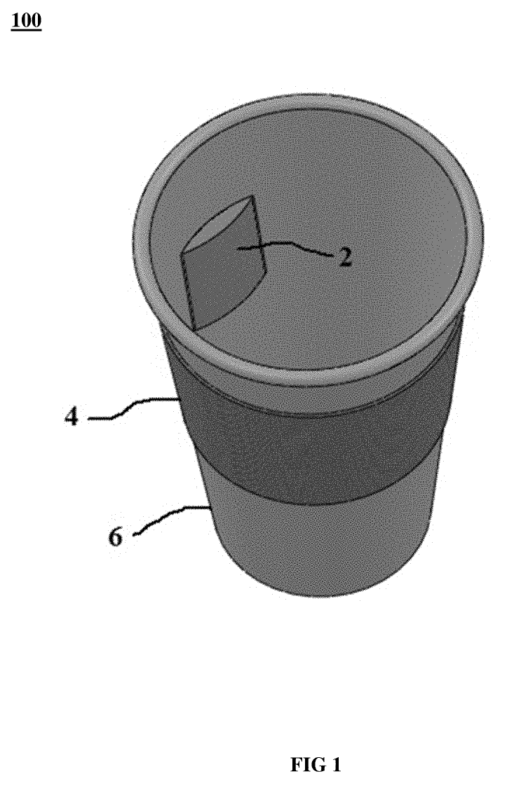

We refer now to the various figures in general, and to FIG. 1 in particular. We discuss here an apparatus 100 for infusion of dry material into a liquid, the apparatus comprising: a cup 6 having a sidewall with an internal surface and an external surface, a closed bottom, and an open top defined by a lip; a container 2 having an edge perimeter, where said container is fixedly attached to the container 2 sidewall inner surface via mated communication with said edge perimeter; and a sleeve 4, having a sleeve inner surface and a sleeve outer surface, where said sleeve is insertedly communicative about said container 6 such that container sidewall outer surface is slidingly communicative with said sleeve inner surface.

Cup 6

Cup 6, as disclosed in this embodiment, is a cup, mug, or other container suitably configured to hold the desired liquid. For example, if the liquid contained will be hot, then the construction of cup 6 shall be such as to safely contain said hot liquid. The cup 6 has a side wall, with an inner surface, outer surface, top edge and bottom edge. The side wall is configured to form a roughly cylindrical or conical shape, although other shapes are contemplated and limited only by way of manufacturing process. The cup further has a bottom in proximate communication with the side wall bottom edge and a lip around the perimeter of the side wall upper edge. Though not required, it is contemplated that cup 6 be constructed of disposable and recyclable materials.

Container 2

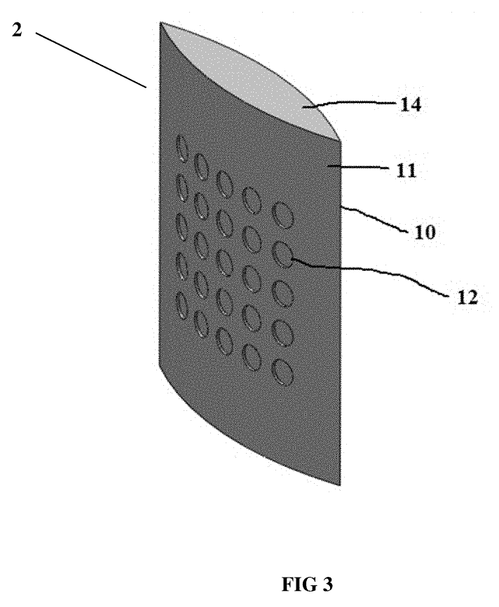

The container 2 is completely enclosed with perforations 12 on one side 8 to allow the liquid to enter the container 2 and come into contact with the contents of the container 2. The contents of the container 2 can be filled by the user or pre-filled by the manufacturer with a variety of infusion materials, such as whole leaf tea. The container's perforated side 8 is affixed to the cup 6 side wall along the edges, perimeter, at specific points, or by a tension piece—not complexly affixed along the entire adjacent side wall—enabling the perforated side 8 to partially separate from the side wall of the teacup. FIG. 3 illustrates a detailed view of container 2 according to an embodiment of the present invention.

### Further Embodiments Incorporating Variations of the Container Component

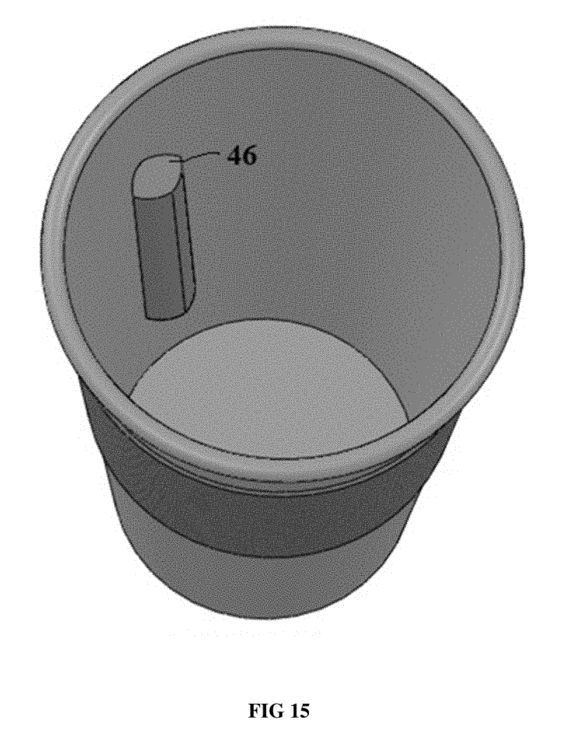

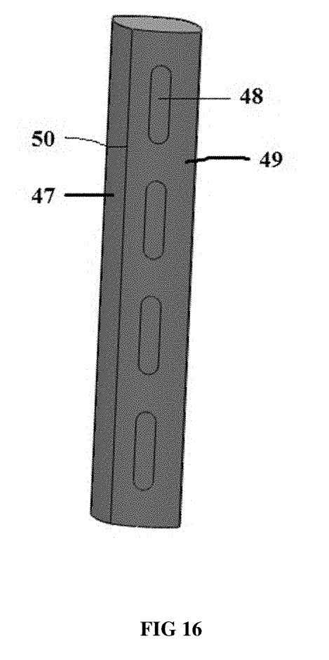

FIG. 15 illustrates another embodiment of the container 46. The container 46 is mounted to the cup along a rotating axis 50 (see FIG. 16). The container's contents are exposed to the water when the perforations 48 are not fully pressed against the cup's side wall. When the sleeve's indentation is pressed against the container's non-perforated side 47, the perforated side 49 is pressed against the cup's side wall, and the tea container's contents are cut off from the water. When the sleeve's indentation is pressed against the container's perforated side 49, the container's contents will be exposed to the water and allow for infusion.

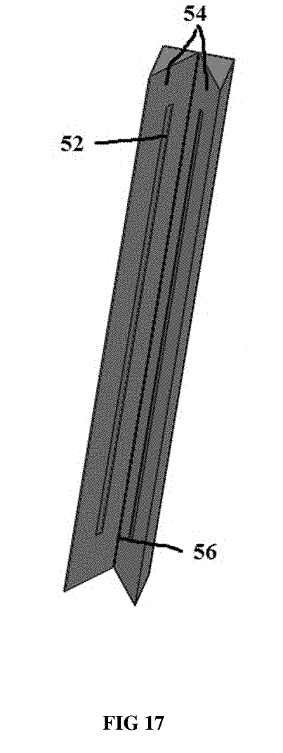

FIG. 17 illustrates an embodiment of another container design. The container will house tea or other infusing products. The water can mix with the tea through perforations 52 in the position shown. The tea container can be sealed, thus halting the flow of water to the tea, by moving either or both sides 54 together along the edge 56.

Sleeve 4

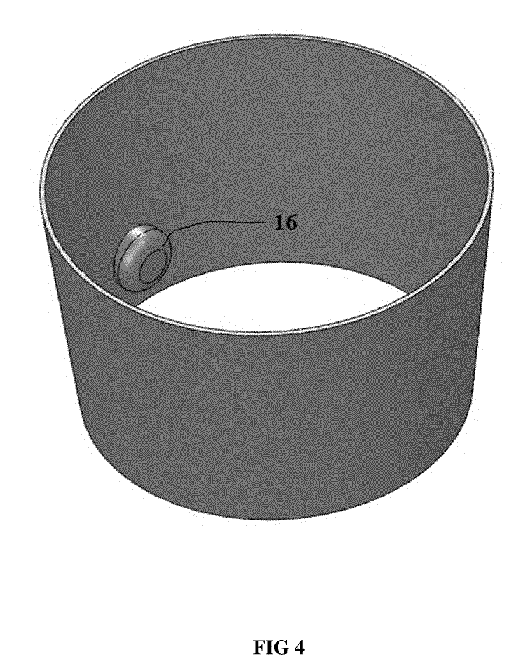

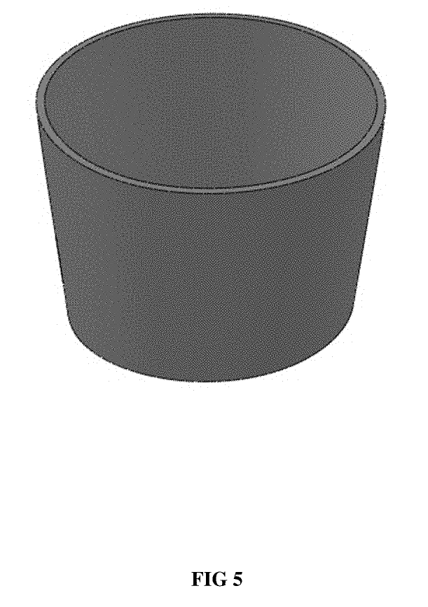

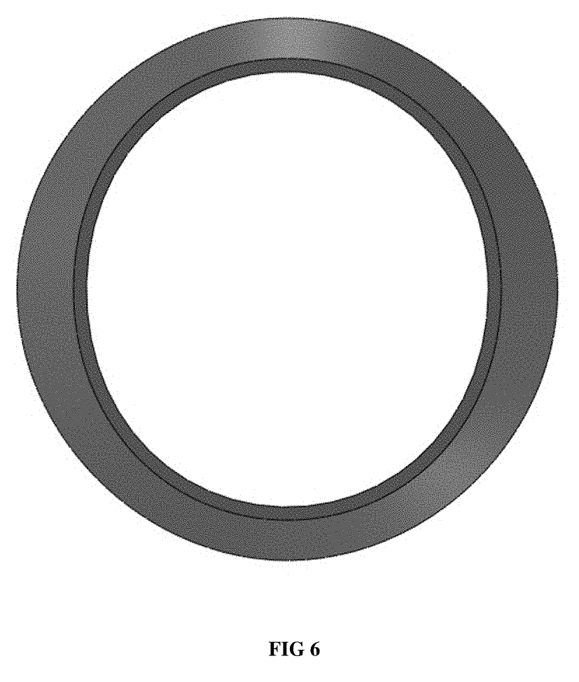

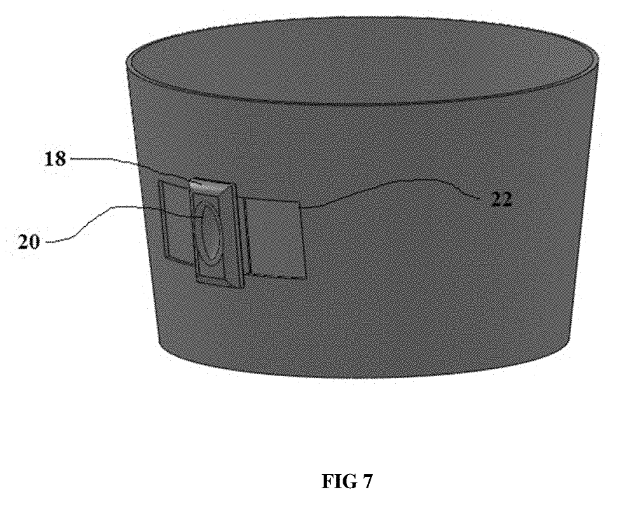

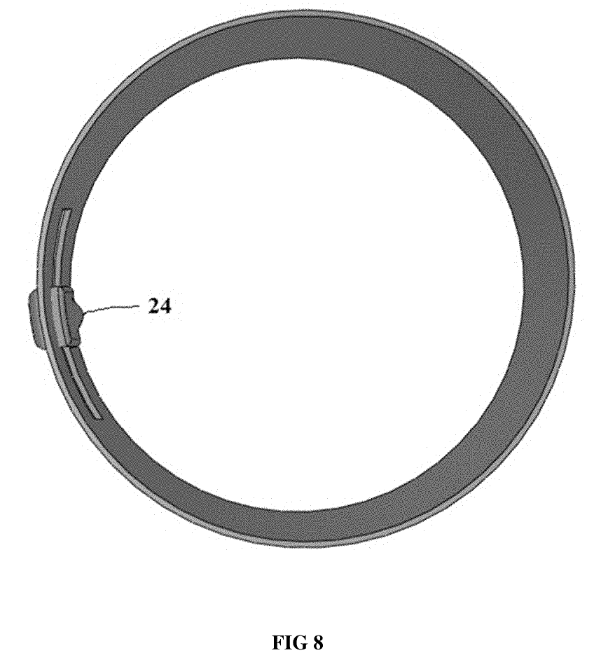

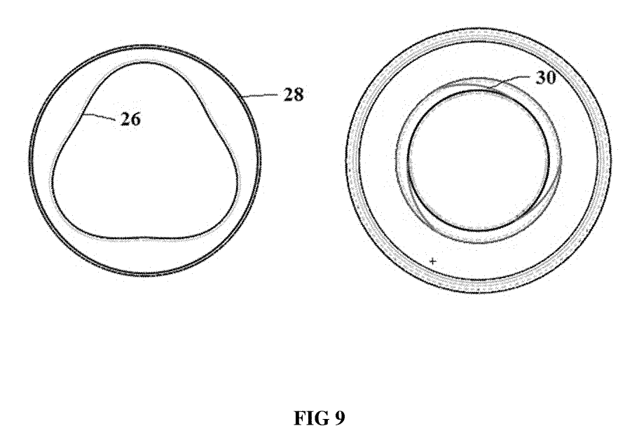

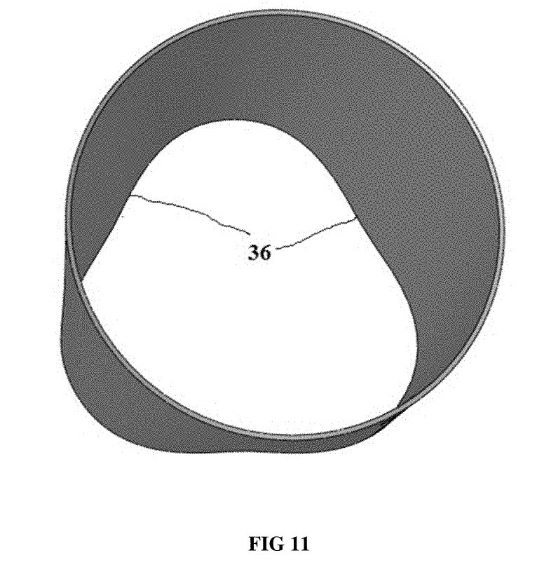

In embodiments, sleeve 4 is basically cylindrical or conical, preferably taking a similar shape as cup 2. Sleeve 4 has a side wall with an inner surface and an outer surface defining an upper edge and a lower edge. The sleeve 4 can take on various shapes and sizes—see FIG. 4, FIG. 5, FIG. 6, FIG. 7, FIG. 8, FIG. 9, and FIG. 11. In each embodiment, the sleeve 4 has an additional feature which locally produces an indent or deformation of the side wall of the cup 6, either inward and/or outward, altering the position of the container 2. The various figures disclose various embodiments of this deformation feature, for example, protrusion 16 (FIG. 4), protrusion 24 (FIG. 8), edge variation/deformation 26 and 30 (FIG. 9) and 36 (FIG. 11).

FIG. 5 and FIG. 6 illustrate alternative embodiments of the sleeve component. This sleeve does not use a protrusion 16 but maintains a circular top diameter configured to match the diameter of the cup and an elliptical bottom shape 17 to deform the cup inward and outward on each side.

FIG. 7 illustrates another sleeve embodiment. Here, the sleeve does not move but maintains an opening 22 and a sliding thumb piece 18 that serves to indent the cup. The user rotates the sliding thumb piece 18, thereby pushing the container 2 away from the cup's internal side wall with the thumb slide's indentation point 24.

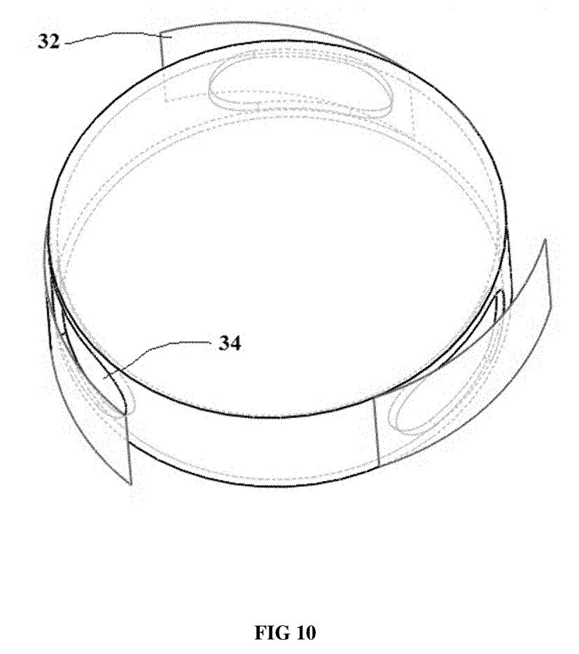

FIG. 9 shows a top view of another embodiment of the invention. FIG. 10 is another tea container design located at the bottom of the teacup. The container in FIG. 10 has tea located inside. The container has multiple openings 34 to allow water to mix the tea inside the container. The sleeve 28 has multiple indentations 26 that will press against the container's sealing flaps 30 to close the openings 34 and stop the tea from interacting with the water.

Referring, for example, to FIG. 4, as the sleeve 4 is rotated by the user, the protrusion 16 will rotate correspondingly. When the protrusion 16 is pushed against the cup 6 in the area adjacent to container 2, the container partially separates from the cup's side wall due to the deformation caused by protrusion 16, and allows the contents of the container to mix with the water through the container's perforations 12. When the protrusion 16 is not pushing against the container 2, the container's perforated side 8 maintains mating contact with the cup's side wall to create a seal and stop the flow of water to the container's contents.

The sleeve 4 additionally serves as an insulating layer between the user and the cup containing the heated liquid.

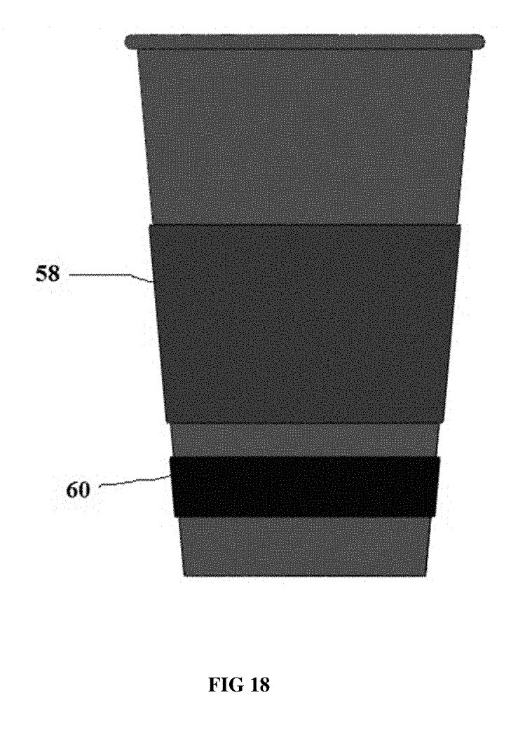

FIG. 18 illustrates another embodiment of the invention having an upper sleeve 58 and a lower sleeve 60. The upper sleeve 58 is stationary and protects the user's hand from the hot liquid inside the cup. The lower sleeve 60 rotates to indent the cup at the indentation identified in FIG. 4.

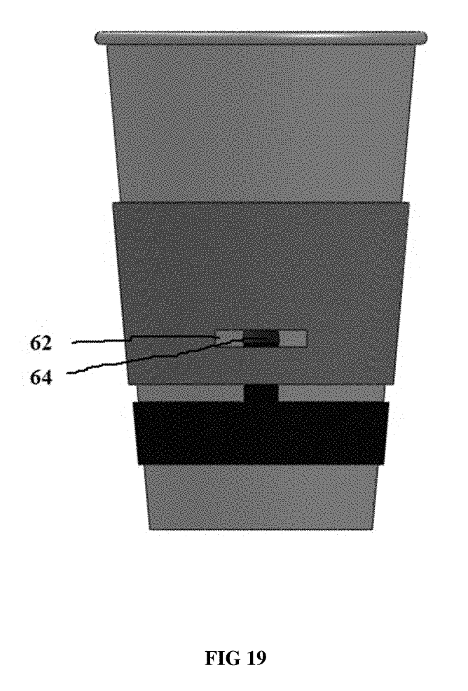

FIG. 19 illustrates a right side view of the apparatus embodiment shown in FIG. 18. The upper sleeve 58 has openings 62 for the insertion of the lower sleeve's 60 hooks 64. The opening 62 is located on both sides of the cup to prevent the user from pulling the lower sleeve off the cup and to control the lower sleeve's rotation.

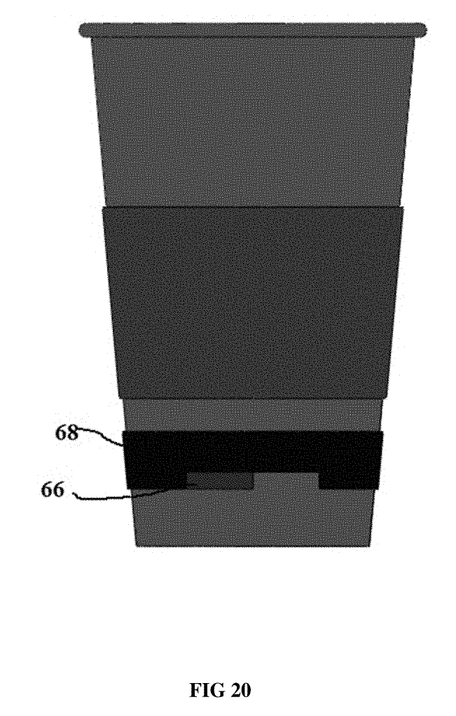

FIG. 20 illustrates an embodiment of the invention having a lower sleeve 68 that is locked in place by two stationary pieces 66. The pieces are located on both sides of the cup to prevent the user from pulling the lower sleeve 68 off the cup and to control the lower sleeve's rotation.

Related System and Method

Embodiments of the invention contemplate a system and method related to the apparatus 100 discussed above. The system 100′ comprises: an apparatus 100; a composition of matter to be infused (such as tea); and an infusion liquid (such as water). A method of using the disclosed apparatus 100 in a system 100′ in order to produce an infusion comprises the following: an apparatus 100, containing a desired amount of a composition of matter to be infused, is provided; a desired amount of water at the desired temperature is provided; the user pours the water into the cup portion of the apparatus 100 so that the water level in the cup is at least to the top of the container 2 component of the apparatus 100; the user rotates the sleeve 4 to a position where the sleeve's deformation and/or indentation point pushes against the cup's side wall, which causes the container's perforated side to separate from mated communication with the cup side wall inner surface, thereby allowing the water to enter container via the container perforations 12 and to come into communication with the composition of matter contained within container 2; by rotating the sleeve to another position, the sleeve's indentation and/or deformation point is not in contact with the container and the container's contents are shut off from the water, thereby halting the steeping process; the user can sift the contents of the container 2 by rotating the sleeve 4 back and forth. In this way, a user can utilize apparatus 100 in system 100′ in order to create a desired infusion.

### Another Embodiment, Apparatus 200

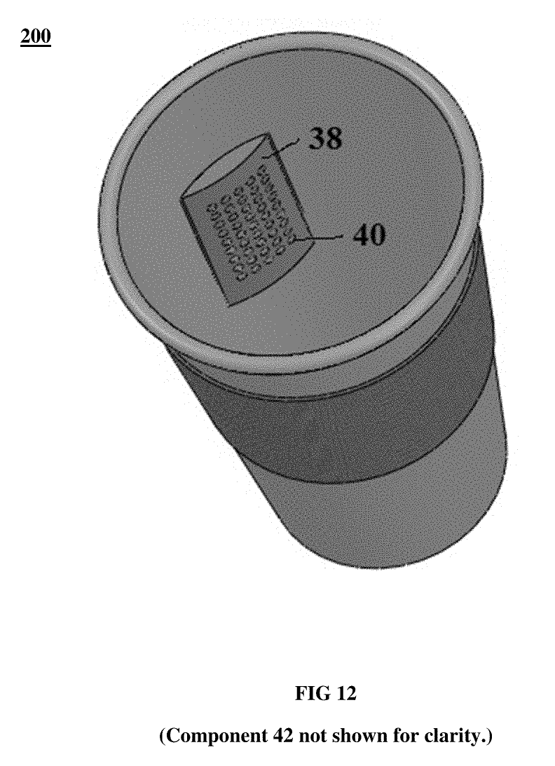

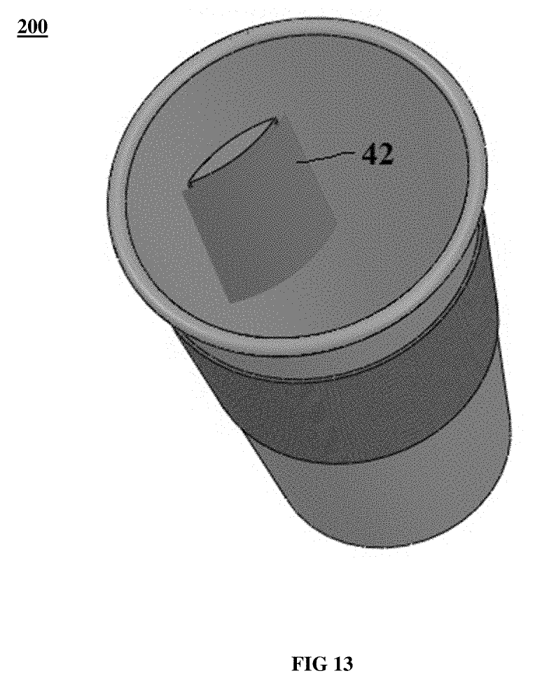

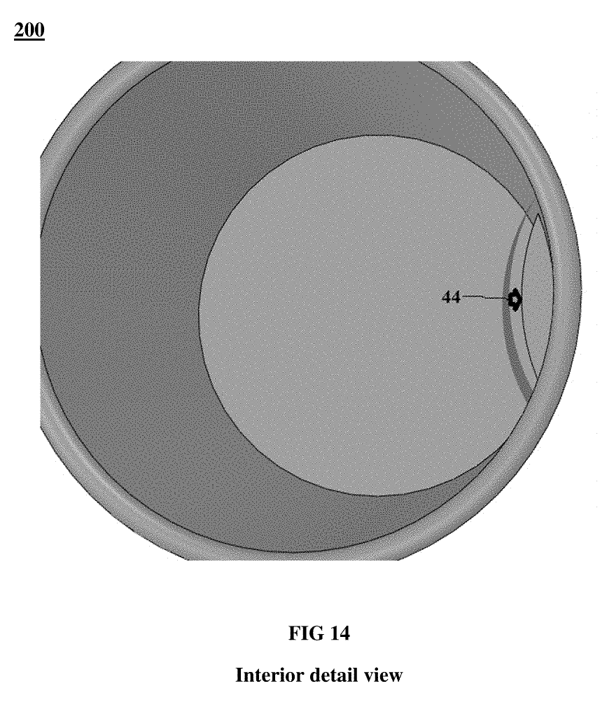

Another embodiment of the invention, apparatus 200, is shown in FIGS. 12 and 13. In FIG. 12, a tea container 38 is mounted to the side wall of a cup. Tea or other infusing product is placed inside the tea container by the user or prefilled by the manufacturer. A piece of sealing paper 42 (see FIG. 13) is also attached to the side wall of the cup so that part of the tea container is not visible to the user. The sealing paper 42 is mounted to the side wall cup on either side of the container 38. A gap 44 (see FIG. 14) between the sealing paper 42 and the tea container 38 will allow the teacup's liquid to enter the tea container 38 through the perforations 40. As the user rotates the sleeve (as described above), the sleeve's indentation will push the tea container 38 towards the center of the cup. This action will cause the tea container 38 to be pushed against the sealing paper, thereby sealing the tea container's perforations 40 with the sealing papers inside wall, and blocking the flow of water to the container's contents. When the sleeve is rotated, such that the sleeve's indented section is no longer adjacent to and pushing against the tea container 38, the tea container is pulled away from the sealing paper 42, allowing the water inside the cup to enter the container and mix with the infusing product. While similar to the components and construction of the embodiment shown and described in apparatus 100, it is noted that the perforations of the container in apparatus 200 are on the opposite side of the container—specifically, not facing the cup sidewall inner surface, but, rather, facing the center of the cup interior.

### Further Embodiment, Apparatus 300

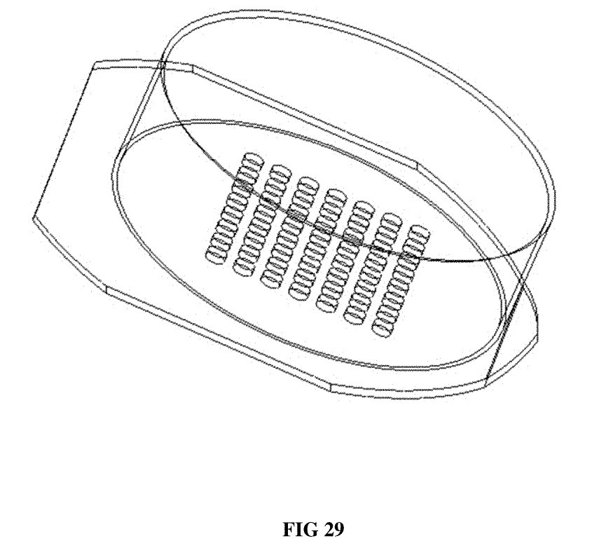

We refer now to the figures in general and, specifically, to FIGS. 20-29. In this embodiment, apparatus 300 discloses, as in the previous embodiments, a vessel for producing an infusion where the apparatus 300 is comprised of a cup 70, a container 74, and a lower sleeve 68.

As previously described, FIG. 20 illustrates a lower sleeve 68 that is locked in place by two stationary pieces 66. The pieces are located on both sides of the cup 70 to prevent the user from pulling the lower sleeve 68 off the cup and to control the lower sleeve's rotation.

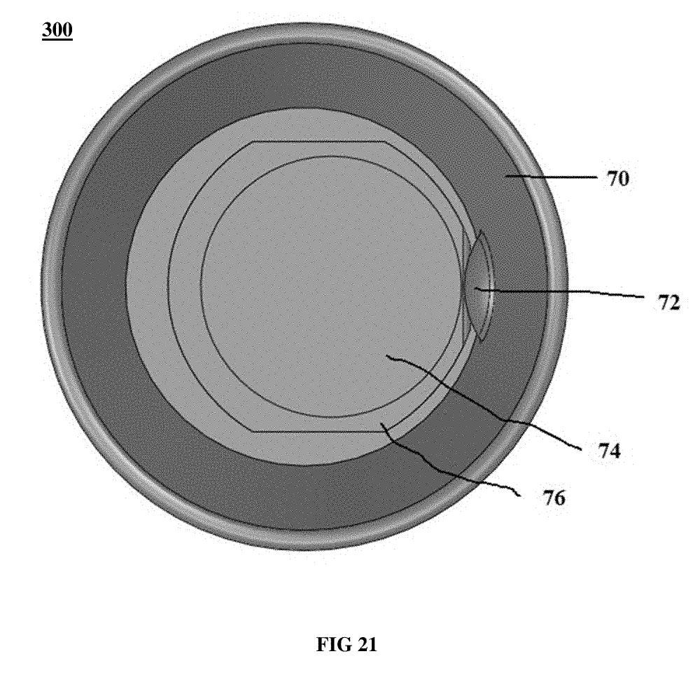

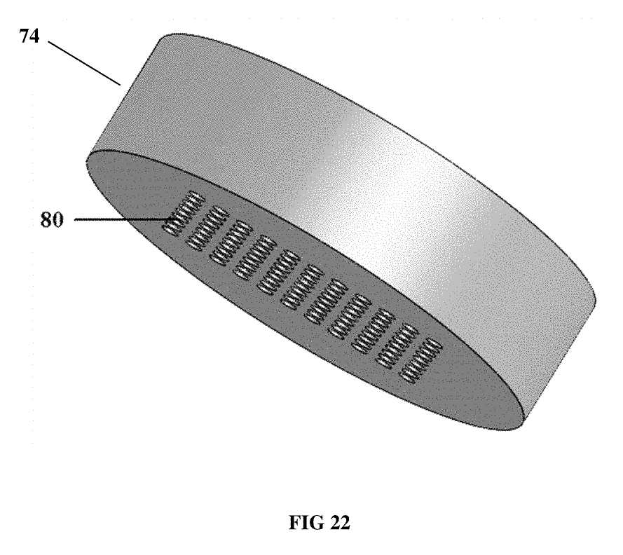

Referring now to FIG. 21, we discuss a paper cup 70 indented by the sleeve's indentation 16 (not visible in this view), causing the cup 70 to deform inward at 72. A container 74 is attached to the bottom of the cup by a holding flap 76. An infusing substance (eg. tea, coffee, energy powder, fruit, etc.) is integral to the container. The container, shown in isolation in FIG. 22, has perforations 80 at the bottom of the container 74. The infusing substances are closed off from the surrounding water when the container is mated to the bottom of the cup and/or the perforations 80 are pressed against the bottom of the cup or against the holding flap 76. The infusing material can mix with the surrounding water when the container 74 is in the open position—not pressed against the bottom of the cup or holding flap 76.

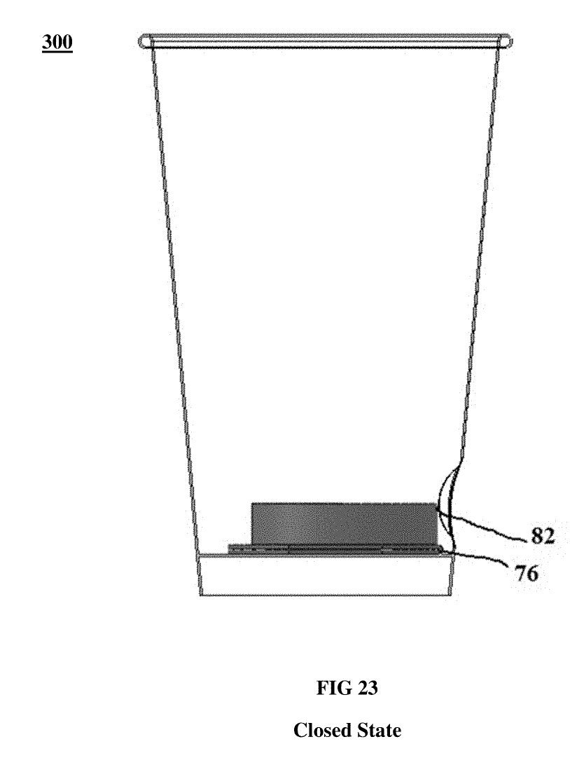

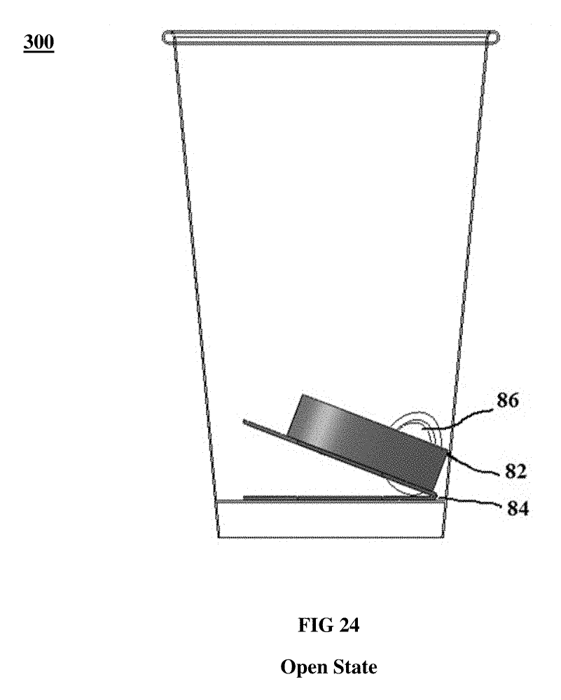

A side view of this embodiment, in the closed position, is shown in FIG. 23. The cup 70 is shown in wireframe form so the interior of the cup can be seen. The container 74 is shown here in the closed position, as the container is parallel to the bottom of the cup, such that the perforations are sealed, and the infusing substance cannot interact with the surrounding water. In comparison, FIG. 24 shows the embodiment in the open position, as the container's perforations 80 are not in contact with the bottom of the cup and water can enter the container and mix with the infusing substance.

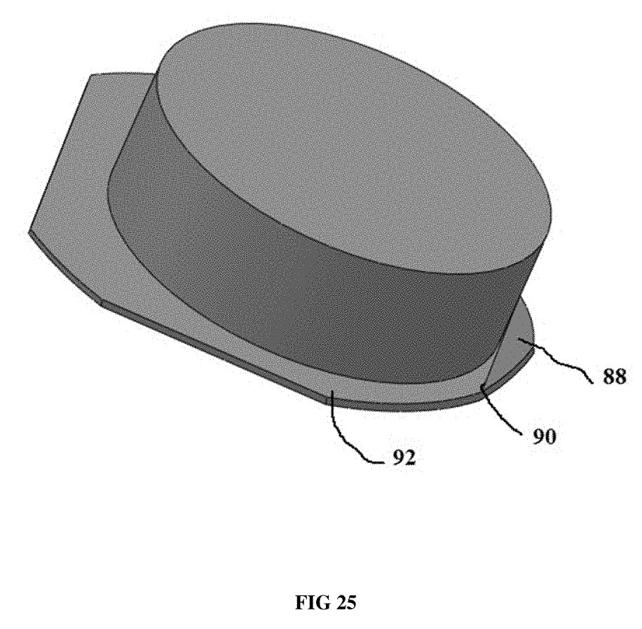

The user can selectively control when the container is in the open and closed position by rotating the lower sleeve 68—corresponding to when the indentation is in contact with or located away from the container's edge 82. The container is in the closed position when the sleeve's indentation 16 deforms the cup's wall 70, which is in line with the container's edge 82 causing the container to be pushed away from the side wall and lay flat against the bottom of the cup. When the lower sleeve's indentation 16 is rotated, such that the indentation is no longer aligned 86 with the container's edge 82, the container 74 will rise due to its buoyant properties (made from paper, plastic, fiber composite or containing air) and allow the infusing substance to mix with the water. Since the container is hingedly attached to the bottom of the container by a fold 84 or score line 90 (FIG. 25), the container will only move upward along one axis. The container will stop rising/tilting when the container's edge 82 makes contact with the cup's side wall 82. The indentation 86 shown in FIG. 24 is not in contact with the container's edge 82.

FIG. 25 shows the container in isolation with an attaching member 92. The perforations 80, as seen in FIG. 22, are located at the bottom of the container 74. The container 74 is partially attached to the bottom of the cup by the attaching member's section 88 to the right of the score line 90. This allows the container to pivot along the score line 90.

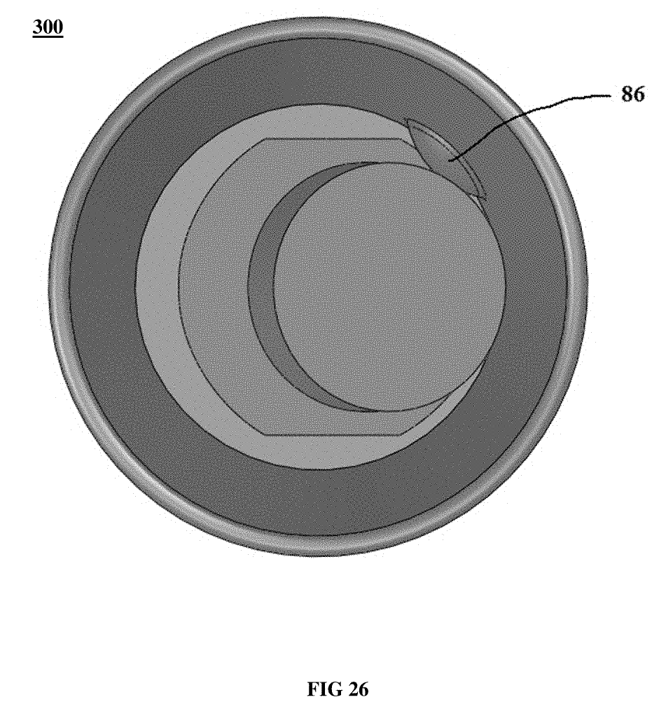

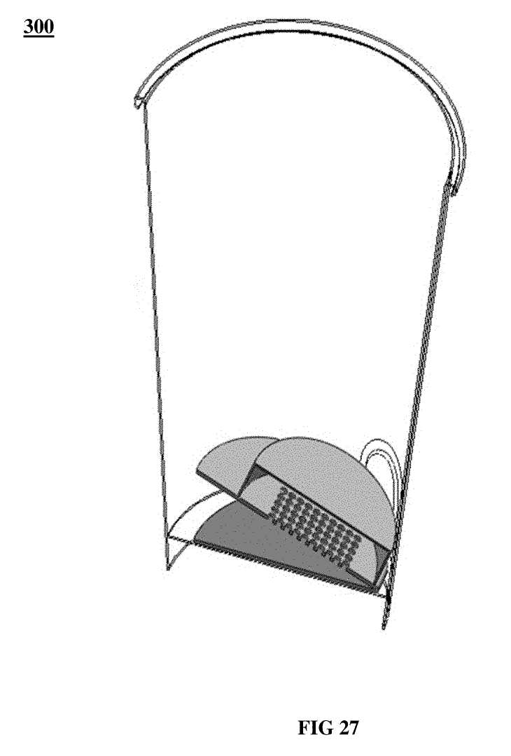

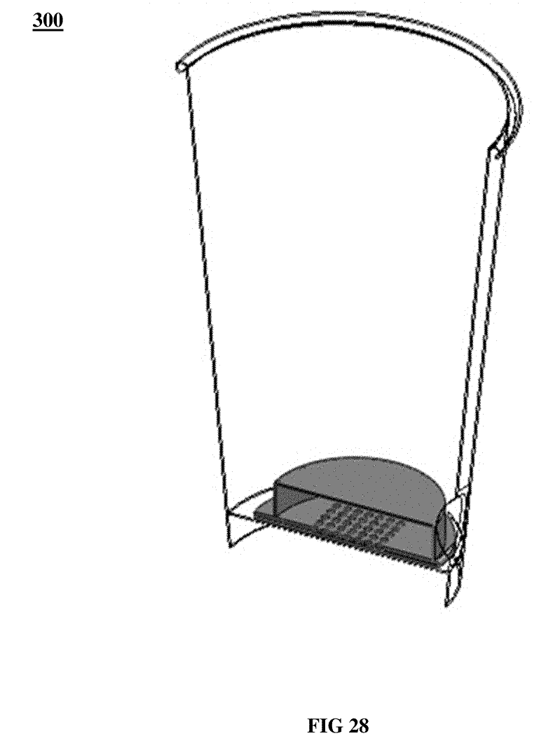

A top view of the open position from FIG. 24 is illustrated in FIG. 26. The sleeve is in the open position because the indentation 86 is to the side of the container and not pushing against the container's edge 82. FIG. 27 is a perspective, section view of the open position shown in FIG. 24. FIG. 28 is a perspective, section view of the closed position shown in FIG. 23.

Related System and Method

Embodiments of the invention contemplate a system and method related to the apparatus 300 discussed above. The system 300′ comprises: an apparatus 300; a composition of matter to be infused (such as tea); and an infusion liquid (such as water). A method of using the disclosed apparatus 300 in a system 300′ in order to produce an infusion comprises the following: an apparatus 300, containing a desired amount of a composition of matter to be infused, is provided; a desired amount of water at the desired temperature is provided; the user pours the desired amount of water into the cup portion of the apparatus 300; the user rotates the lower sleeve 68 to one of two positions—open or closed; in the closed position, the container's contents will be closed off from the surrounding liquid; as the user rotates the sleeve into the open position, the container will begin to tilt/rise and the surrounding liquid will be able to enter the container; once the container begins filling with the surrounding liquid, the infusing substance inside the container will release its properties outside the container—eg. tea or coffee will start steeping/brewing; when the user moves the sleeve back and forth, the container will move up and down, causing the liquid to move thereby sifting the infusing substance evenly throughout the cup's liquid. In this way, a user can utilize apparatus 300 in system 300′ in order to create a desired infusion.

### Preferred Embodiment, Apparatus 400

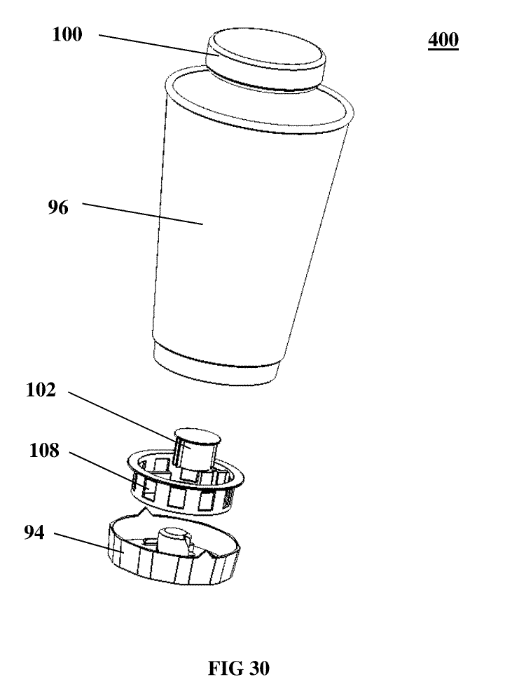

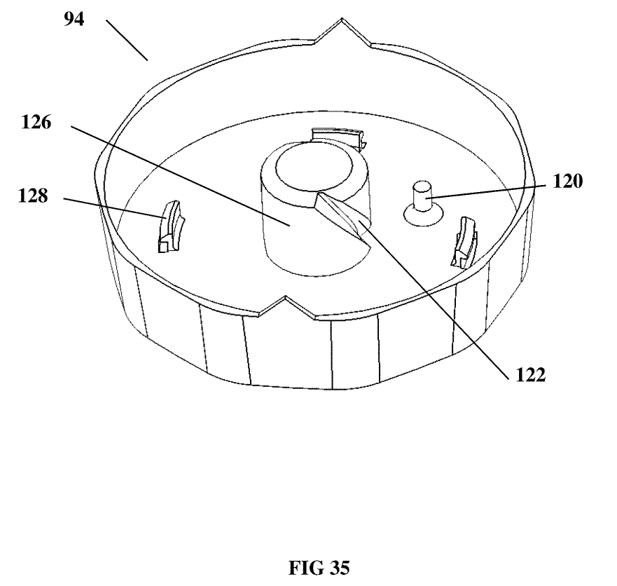

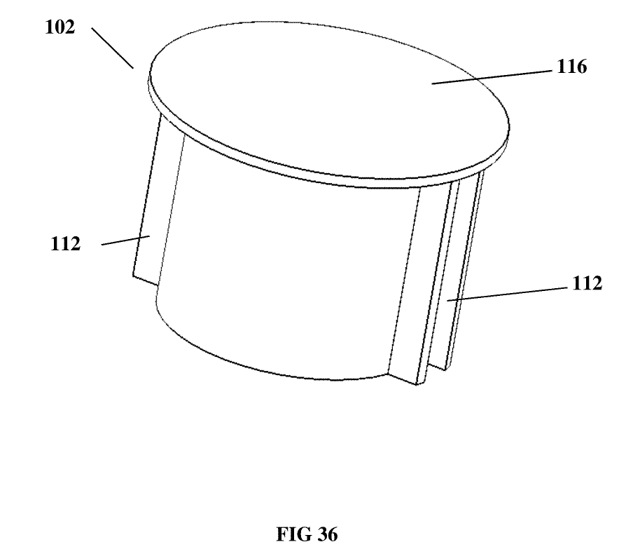

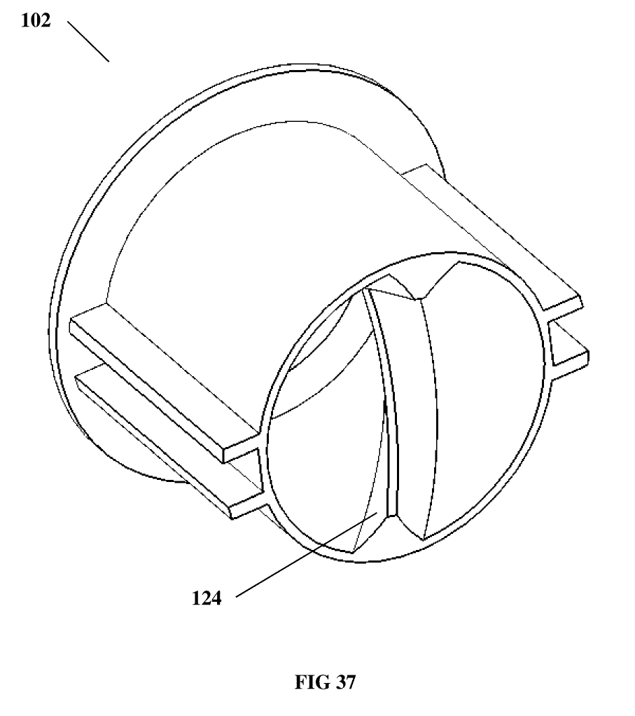

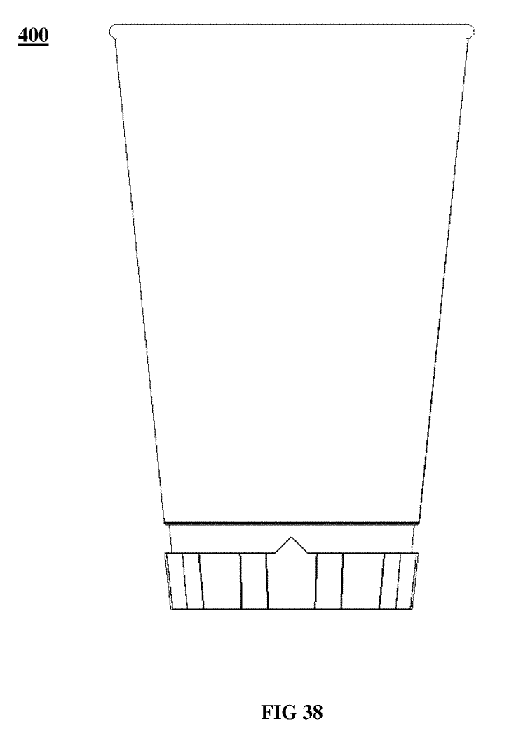

Referring now to the figures in general, and to FIGS. 30-38, in particular, we discuss now a preferred embodiment of the present invention. In this embodiment, the components of apparatus 400 are configured such that the user affects a container that is located inside a cup via a local deformation to the bottom of the cup rather than the side wall.

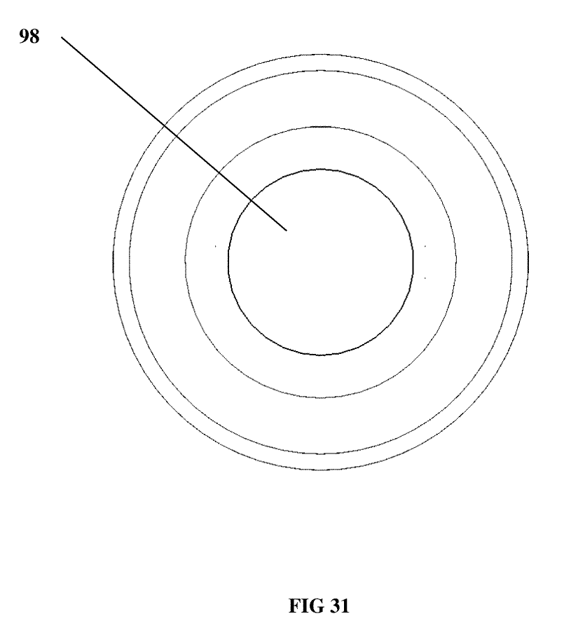

An embodiment of the invention in the form of an apparatus 400 is comprised of: a container 100; a cup 96; an elastic member integral to the bottom of the cup 98 (see FIG. 31); a lower ring 94; a piston 102; and a support bracket 108.

Tea, coffee, or other infusing substances are placed integral to the container 100 by the manufacturer or user.

The cup 96 is a single-wall or double-wall cup as may be known in the art, but with an elastic member 98 integral to the base of the cup. The elastic member 98 provides a water-tight seal at the bottom of the cup, while also allowing the user to flex or move the elastic member to the desired location. In this way, the perforations of container 100 can mate to the elastic member, stopping the flow of liquid to the infusion material. The elastic member 98 also provides the area of local deformation described throughout this disclosure.

While this embodiment discloses an elastic member, it is contemplated to be within the scope of the invention that the manner in which the cup is locally deformed may be accomplished by other methods as well may be available in the art while still remaining within the scope of being locally deformable as disclosed throughout. By way of example and not limitation, the local deformation affected via the elastic member may also be accomplished via overlapping folds in the cup material, pleats, slits, or other constructs.

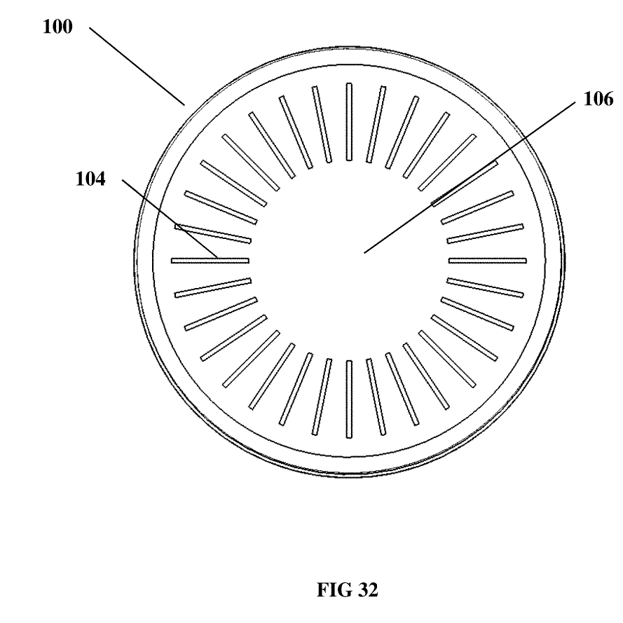

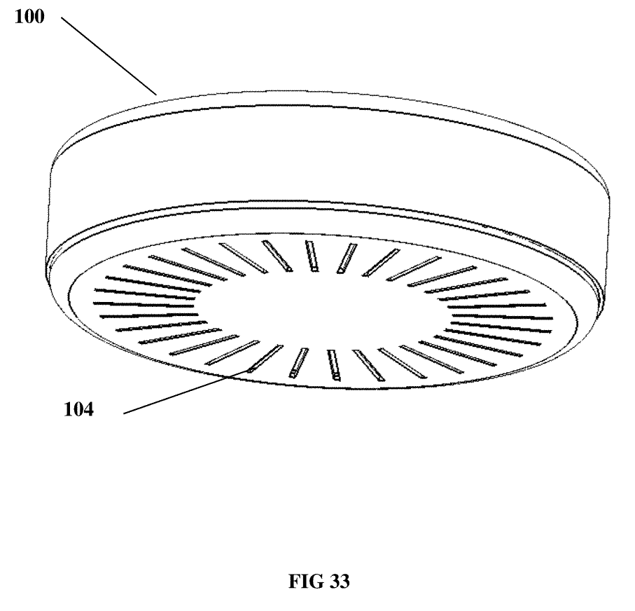

FIG. 32 and FIG. 33 show a bottom and perspective view of the container. The container 100 is primarily cylindrical in shape to maximize the internal volume for the infusing substance, although it is within the scope and spirit of this disclosure that the container 100 is not limited to a cylindrical shape. A localized area of the bottom of the container 100 is attached to the elastic member 98 on the inside of the cup at the center 106 of the container 100, see FIG. 32. The container's bottom portion also has perforations, or openings 104, to allow water to enter the container when the user so desires. The openings 104 are located on a segment of the container not affixed to the elastic member, such that the container, when the container's bottom section lies flat against the elastic member, the openings 104 are not exposed to the water; however, when the container 100 is pushed away from the elastic member, the container remains attached to the elastic member and the openings 104 allow water to enter the container 100.

In this embodiment, the support bracket 108, lower ring 94, and piston 102 are located primarily below the cup 96. It is contemplated to be within the scope and spirit of the invention for embodiments of the apparatus to include other ways to locally deform the bottom of the cup such as to affect the container as disclosed. For example, embodiments of the lower ring, may be, instead of below the cup, at some other location around the cup side wall such that linear or rotational movement of the lower ring may cause a local deformation of the cup, thereby affecting the container.

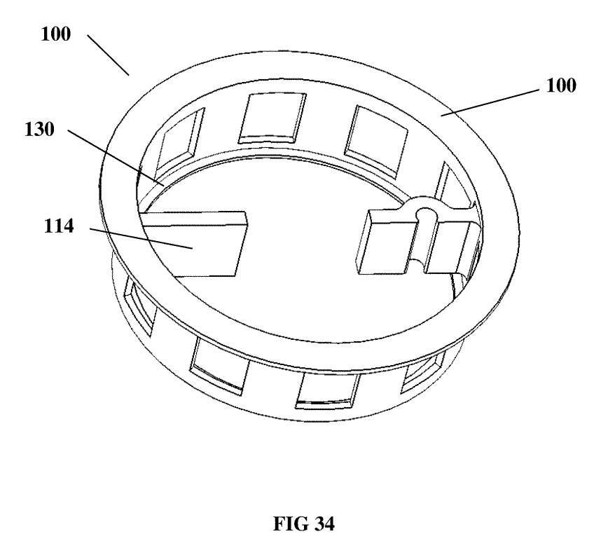

FIG. 34 shows a perspective view of the support bracket 108 according to an embodiment of the invention. The support bracket 108 is affixed to the elastic member or underside of the cup at its top section 118—generally along the cup's side wall or the underside of the cup bottom outside of the locally deformable area. The support bracket's purpose is to guide the piston 102 along its extrusion guides 114, provide a method of attachment 130 to the lower ring's snap-fit hooks 128, restrict the lower ring's vertical movement, and control the lower ring's rotational movement.

In this embodiment, the lower ring 94 is attached to the support bracket 96 with snap-fit hooks 128. The lower ring has a stopper 120 to control its rotational movement—the stopper 120 comes in contact with the support bracket's extrusion guides 114. The lower ring has a protrusion 126 with a female screw thread 122.

The top portion of the piston 116 is affixed to the center portion of the elastic member 98 on the bottom of the cup—not inside the cup like the tea pod 100. The piston 102 is attached to the elastic member at a position tangent to the pod's attachment. The piston 102 has two guide rails 112 that correspond with extrusion guides 114 on the support bracket. These guide rails 112 restrict the piston's rotational movement and only allow the piston to travel in the vertical direction.

The piston 102 is formed in the shape of a dome to fit over the lower ring's protrusion 126. The piston 102 has a male screw thread 124 that corresponds with the lower ring′ female screw thread 122 to transfer the lower ring's rotational movement into a vertical movement for the piston. As the lower ring 94 is rotated, the piston 102 is forced upwards against the elastic bottom 98, thereby pushing the pod away from the elastic member and bottom of the cup.

Method of Use for Apparatus 400

When the lower ring 94 is in the “closed” position, the piston is in the furthest downward position, pulling the tea pod flush against the elastic member or bottom of the cup. The water inside the cup cannot enter the openings and interact with the infusing substance. As the user rotates the lower ring to the “open” position, the piston is forced upward; pushing the pod away from the bottom of the cup and water inside the cup can enter the pod's openings. To stop the water and infusing material from interacting, the lower ring is rotated back to the “closed” position where the pod is pulled against the bottom of the cup and the openings are closed off to the surrounding water. By rotating the lower sleeve quickly, the pod is forced up and down rapidly, agitating the water and allowing the infusing material to evenly disperse throughout the cup.

It will be appreciated that the devices, apparatus, and systems described above are set forth by way of example and not of limitation. Numerous variations, additions, omissions, and other modifications will be apparent to one of ordinary skill in the art.

It is within the spirit and scope of the present invention that one or more components of the apparatus, as disclosed herein, may be offered to the user separately. As an example, a series of containers, as described herein, may be offered with different infusion materials integral thereto. A cup that is configured to be locally deformable, as described herein, may be offered separately. In this way, a user has the option to re-use the cup portion while discarding the “consumable” containers at will.

While particular embodiments of the present invention have been shown and described, it will be apparent to those skilled in the art that various changes and modifications in form and details may be made therein without departing from the spirit and scope of the invention as defined by the following claims. The claims that follow are intended to include all such variations and modifications that might fall within their scope, and should be interpreted in the broadest sense allowable by law.

In light of the foregoing description, it should be recognized that embodiments in accordance with the present invention can be realized in numerous configurations contemplated to be within the scope and spirit of the claims. Additionally, the description above is intended by way of example only and is not intended to limit the present invention in any way, except as set forth in the claims.

What is claimed is:

1. An apparatus for infusing material into a surrounding liquid, the apparatus comprising:
a vessel, having a vessel body defining a vessel interior and a vessel exterior, the vessel interior configured to contain a liquid, and the vessel body configured to be locally deformable, variable between a deformed state and an undeformed state; and
a container, having a container body defining a container interior and a container exterior, the container interior configured to contain an infusion material, and the container body configured with a one or more perforation integral to the container body passing from the container exterior to the container interior, where said container is operatively communicative with said vessel interior such that when said vessel body is in said undeformed state the one or more perforation is in contact with said vessel body, and when said vessel body is in said deformed state the one or more perforation is separated from said vessel body and thereby exposed to said vessel interior.

2. The apparatus of claim 1 further comprising a lid configured to releasably attach to said vessel body.

3. An apparatus for producing an infusion, the apparatus comprising:
a cup having a sidewall defining a cup interior and cup exterior, the sidewall having an inner surface, an outer surface, a proximal upper edge, a distal lower edge, an opening defined by said upper edge, and a bottom defined by and proximate to said lower edge;
an elastic member coplanar with and integral to said cup bottom, the elastic member configured to be elastically deformable both towards said cup interior and said cup exterior;
a container, located in said cup interior, fixedly attached to said elastic member;
a support bracket, located at said cup exterior, fixedly attached to said elastic member, said support bracket having a one or more extrusion guide and a one or more attachment receiver;
a piston, having a top portion, an internally threaded body portion extending perpendicularly from the top portion, and a one or more guide rail external to the internally threaded body portion, where said top portion is fixedly attached to said elastic member and said one or more guide rail is slidingly communicative with said one or more support bracket extrusion guide; and
a lower ring having a one or more attachment protrusion configured to removable attach to said support bracket one or more attachment receiver, an externally grooved protrusion configured to thread into said piston internally threaded body portion, and a one or more stopper protrusion configured to selectively contact said one or more support bracket extrusion guide.

4. The apparatus of claim 3, the apparatus further comprising a lid.

5. An apparatus for producing an infusion, the apparatus comprising:
a cup having a sidewall defining a cup interior and cup exterior, the sidewall having an inner surface, an outer surface, a proximal upper edge, a distal lower edge, an opening defined by said upper edge, and a bottom defined by and proximate to said lower edge;
a container, with a top, bottom, front, and back defining an interior, an exterior, a perimeter edge on the front, and a one or more perforation on the front from the exterior to the interior, flexibly attached via at least a portion of the perimeter edge to said cup sidewall inner surface, configured such that the front is pressed against said cup sidewall inner surface; and
a sleeve, having a sleeve inner surface and a sleeve outer surface defining a sleeve interior and a sleeve exterior, where said sleeve is insertedly communicative about said cup exterior such that said cup sidewall outer surface is slidingly communicative with said sleeve inner surface, the sleeve further comprising a protrusion extending from the sleeve inner surface towards sleeve interior, said protrusion configured to contact and locally deform said cup sidewall.

6. The apparatus of claim 5, the apparatus further comprising a lid.

7. A method for producing an infusion using a locally deformable vessel, the method comprising the steps of:
providing a vessel, said vessel configured to be locally deformable;
providing a container inside of said vessel, said container having an amount of infusion material integral thereto;
providing a liquid;
pouring said liquid into said vessel; and
deforming said vessel;
whereby, the liquid co-mingles with the amount of infusion material integral to the container, thereby producing an infusion.
